(19) United States
(12) Patent Application Publication
(10) Pub. No.: US 2014/0333446 A1
(43) Pub. Date: Nov. 13, 2014

(54) SPORTS HELMET NOTIFICATION SYSTEM

(71) Applicant: SAFEBRAIN SYSTEMS, INC., Calgary (CA)

(72) Inventor: Rod J. NEWLOVE, Lake Country (CA)

(73) Assignee: Safebrain Systems, Inc., Calgary (CA)

(21) Appl. No.: 13/891,403

(22) Filed: May 10, 2013

(51) Int. Cl. G08B 21/02

(52) U.S. Cl. CPC G08B 21/02
USPC 340/669

(57) ABSTRACT

A sports helmet notification system to be carried by a helmet has a microcontroller in connection with an accelerometer that measures acceleration in three mutually orthogonal directions, a memory device and a notification device. The microcontroller has a predetermined logging setpoint and a predetermined notification setpoint. The microcontroller is programmed with instructions to record an event in the memory device upon receiving acceleration data from the accelerometer that exceeds the logging setpoint and to activate the notification device upon receiving acceleration data from the accelerometer that exceeds the notification setpoint.

### TECHNICAL FIELD

This relates to a notification system designed for use in a sports helmet.

### BACKGROUND

Head, neck and brain injuries, including concussions, often result from blows to the head and are a common problem in sports such as hockey, football, skiing, snowboarding, etc. While helmets are used in most sports in high risk sports, injuries may still occur. U.S. Pat. No. 5,539,935 (Rush) entitled “Sports Helmet” describes a sensor installed in a helmet for measuring the magnitude and direction of an impact.

It is also known that other situations may benefit from measuring forces applied to a head, such as in military applications or medical applications, such as patients who experience seizures.

### SUMMARY

There is provided a helmet notification system to be carried by a helmet, the notification system comprising an accelerometer that measures acceleration in three mutually orthogonal directions, a memory device, a notification device and a microcontroller that is in communication with the accelerometer, the memory device and the notification device. The microcontroller has a predetermined logging setpoint and a predetermined notification setpoint. The microcontroller is programmed with instructions to: record an event in the memory device upon receiving acceleration data from the accelerometer that exceeds the logging setpoint; and activate the notification device upon receiving acceleration data from the accelerometer that exceeds the notification setpoint.

According to another aspect, the sports helmet notification system may further comprise a clock device in communication with the memory device. The event may comprise acceleration data from the accelerometer and a timestamp from a clock device. The microcontroller may be further programmed to sample the measured acceleration from the accelerometer and the acceleration data of the event may be obtained from the samples.

According to another aspect, the acceleration data may comprise acceleration in each of the three mutually orthogonal directions.

According to another aspect, the memory device may be integrally formed with the microcontroller.

According to another aspect, the sports helmet notification system may further comprise a battery power source.

According to another aspect, the sports helmet notification system may further comprise a connection port for connecting to an external computing device. The connection port may be a wireless connection port or a wired connection port.

According to another aspect, the microcontroller may be programmed to enter a sleep mode after recording events in the memory device or activating the notification device.

According to another aspect, the helmet notification system may further comprise a gyroscope for measuring rotational acceleration applied to the helmet, and wherein the event recording may further comprise readings from the gyroscope.

There is provided a method of tracking the forces applied to a helmet, comprising the steps of measuring the acceleration of the helmet in three mutually orthogonal directions; comparing the measured acceleration against a predetermined logging setpoint and a predetermined notification setpoint; and programming a microcontroller to: record an event in a memory device when the logging setpoint is exceeded; and activate a notification device when notification setpoint is exceeded.

According to another aspect, recording an event comprises recording acceleration data from the accelerometer and a timestamp from a clock device. The microcontroller may be further programmed to sample the measured acceleration from the accelerometer and the acceleration data of the event may be obtained from the samples.

According to another aspect, the acceleration data may comprise acceleration in each of the three mutually orthogonal directions.

According to another aspect, the memory device may be integrally formed with the microcontroller.

According to another aspect, the method may further comprise the step of connecting to an external computing device using a connection port. The connection port may be a wireless or a wired connection port.

According to another aspect, the microcontroller may be programmed to enter a sleep mode after recording events in the memory device or activating the notification device.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of a helmet with the notification system.

FIG. 2 is a schematic view of the notification system.

### DETAILED DESCRIPTION

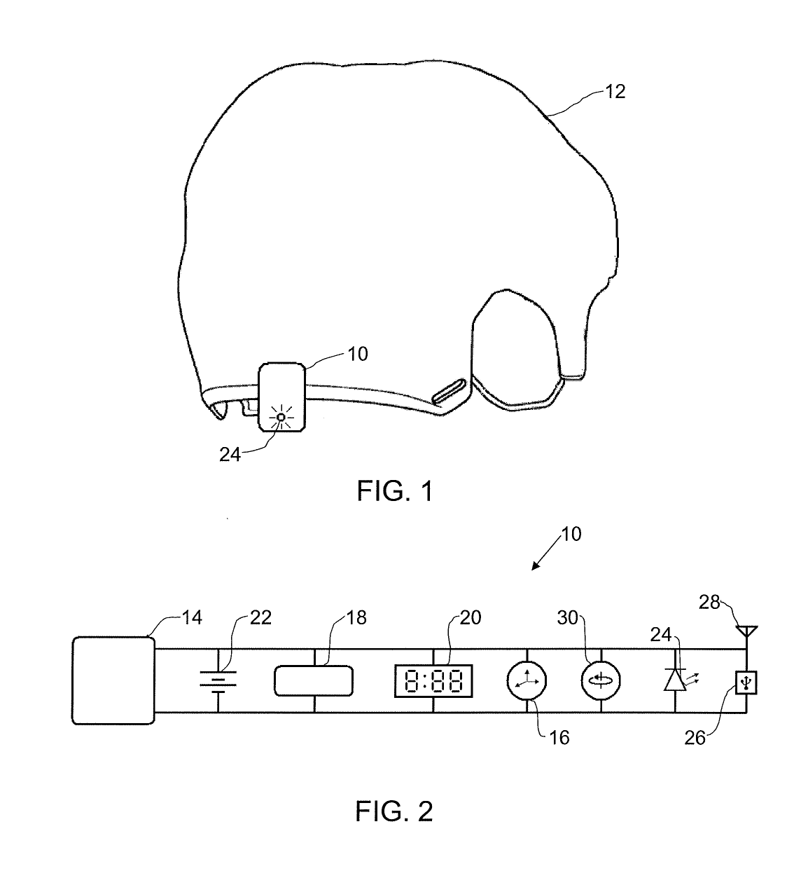

A sports helmet notification system, generally identified by reference numeral 10, will now be described with reference to FIGS. 1 and 2.

### Structure and Relationship of Parts:

Referring to FIG. 1, sports helmet notification system 10 is carried by a helmet 12. Referring to FIG. 2, system 10 has a microcontroller 14 and a 3-axis accelerometer 16. It will be understood that accelerometer 16 may be made up of multiple accelerometers 16 that each measure acceleration along a different axis in order to obtain acceleration in three mutually orthogonal directions. A memory device 18 is used to store data and may be a separate component or integrated with microcontroller 14. Memory device 18 may be integrally formed with microcontroller 14 or may be a separate element. Memory device 18 may also be an external component, such as a computer or hand held device that receives the data wirelessly from microcontroller 14. A clock 20 that preferably measures real time is included to allow readings to be time stamped. Clock 20 may be a separate component or integrated with microcontroller 14. Each of these components receives power from a power source, such as batteries 22. Preferably, system 10 is a low power device that does not require much current, such that it is possible to power system 10 using a permanent disc battery that is relatively lightweight and does not require recharging. A visual indicator, such as an LED indicator 24 is included to notify supervisors when a predetermined event occurs. It is preferred that indicator 24 be an LED as these are generally smaller and require less power than other types of indicators. In addition, there may be a PC interface represented by a USB symbol 26 or circuitry for RF communications represented by antenna 28 to communicate with an external device (not shown). Various types of connections and protocols may be used for communication, as is known in the art.

Microcontroller 14 is preloaded with a notification setpoint as well as a logging setpoint. During normal use, microcontroller 14 may be in a “sleep” mode in order to conserve power, and receives a signal to wake up if the logging setpoint or the notification setpoint is exceeded. It will be understood that the functions of microcontroller 14 may be divided among the various components. For example, accelerometer 16 may be programmed to send a “wake” signal to microcontroller once a certain force has been experienced, such as when one of the setpoints has been reached. It will be understood that the setpoint may be varied, depending on the user's characteristics, their intended activities and their prior history. For example, different setpoints may be specified based on the size or age of a player, their susceptibility to concussions, their prior medical history, the types of conditions that a supervisor wishes to be notified of, etc.

When helmet 12 is in use, 3-axis accelerometer 16 measures the loads applied to the helmet. If the logging setpoint is exceeded, microcontroller 14 samples a number of readings from accelerometer 16 to establish the highest attained “G” force applied to helmet 12. This event, along with the corresponding time from real time clock 20, is then recorded into memory 18. Preferably, the event record will also include other samples aside from the highest attained “G” force, and preferably includes other samples at different times before, after or both before and after the peak “G” force. In one example, the forces may be recorded in time intervals of 1 ms, and may be recorded over a time period of 3 to 5 ms. This allows the event to be more fully characterized, including the entire force that was applied to the helmet. Once microcontroller 14 begins sampling, it may continue to sample even after the force has dropped below a threshold or setpoint. This would allow system 10 to also track, for example, the rebound of the helmet after an event has occurred. While these samples may be below the threshold, they could be important in characterizing the event and the effect on the individual wearing helmet 12.

Referring still to FIG. 2, there may be additional sensors to track movement or forces on helmet 12. For example, a gyroscope 30 is shown as being connected to microcontroller 14. Gyroscope 30 allows rotational forces applied to helmet 12 to be sensed, in addition to the lateral movements detected by accelerometer 16. Gyroscope 30 may be an active sensor similar to accelerometer 16, and have its own predefined logging or notification setpoints to activate microcontroller 14. However, gyroscopes generally have higher current requirements than accelerometers, and this would increase the demands on power source 22, which may require a larger, heavier battery, or more frequent battery replacements or charges. Furthermore, for most purposes, it is unlikely that a logging or notification event would occur without a significant lateral force being applied to helmet 12, which would be detected by accelerometer 16. As such, a user may choose to design gyroscope 30 to become active with microcontroller 14, and to enter a sleep mode otherwise.

If the notification setpoint is exceeded, microcontroller will activate LED indicator 24 on helmet 12. As shown in FIG. 1, LED 24 may protrude down slightly from the back of helmet 12 to improve visibility, or may be at any convenient location on helmet 12. As LED 24 is depicted as being part of system 10, the entire system is shown as being at the back and at the bottom of helmet 12. LED 24 may be designed to continue to flash for a predetermined period, such as for a certain amount of time or until reset, to give coaching or training staff the opportunity to notice the potential injury and take appropriate action.

Preferably, a connection port, or PC Interface 26, is provided to allow the data logged in memory 18 to be downloaded onto an external device for analysis and record-keeping purposes. This may be a wired connection port (as represented by the USB symbol) or alternatively, a wireless connection port may be used, such as an RF transceiver using, for example, WiFi or Bluetooth® technology, to communicate the recorded data.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. The scope of the claims should not be limited by the preferred embodiments set forth in the examples above.

What is claimed is:

1. A helmet notification system to be carried by a helmet, the notification system comprising:
an accelerometer that measures acceleration in three mutually orthogonal directions;
a memory device;
a notification device; and
a microcontroller that is in communication with the accelerometer, the memory device and the notification device, the microcontroller having predetermined logging setpoint and a predetermined notification setpoint, the microcontroller being programmed with instructions to:
record an event in the memory device upon receiving acceleration data from the accelerometer that exceeds the logging setpoint; and
activate the notification device upon receiving acceleration data from the accelerometer that exceeds the notification setpoint.

2. The helmet notification system of claim 1, further comprising a clock device in communication with the microcontroller.

3. The helmet notification system of claim 2, wherein the event comprises acceleration data from the accelerometer and a timestamp from the clock device.

4. The helmet notification system of claim 3, wherein the microcontroller is further programmed to sample the measured acceleration from the accelerometer and the acceleration data of the event is obtained from the samples.

5. The helmet notification system of claim 1, wherein the acceleration data comprises acceleration in each of the three mutually orthogonal directions.

6. The helmet notification system of claim 1, wherein the memory device is integrally formed with the microcontroller.

7. The helmet notification system of claim 1, further comprising a battery power source.

8. The helmet notification system of claim 1, further comprising a connection port for connecting to an external computing device.

9. The helmet notification system of claim 8, wherein the connection port is a wireless connection port.

10. The helmet notification system of claim 8, wherein the connection port is a wired connection port.

11. The helmet notification system of claim 1, wherein the microcontroller is programmed to enter a sleep mode after recording events in the memory device or activating the notification device.

12. The helmet notification system of claim 1, further comprising a gyroscope for measuring rotational acceleration applied to the helmet, and wherein the event recording further comprises readings from the gyroscope.

13. A method of tracking the forces applied to a helmet, comprising the steps of:
measuring the acceleration of the helmet in three mutually orthogonal directions;
comparing the measured acceleration against a predetermined logging setpoint and a predetermined notification setpoint;
programming a microcontroller to:
record an event in a memory device when the logging setpoint is exceeded; and
activate a notification device when notification setpoint is exceeded.

14. The method of claim 13, wherein recording an event comprises recording acceleration data from the accelerometer and a timestamp from a clock device.

15. The method of claim 14, wherein acceleration is measured using an accelerometer and the microcontroller is further programmed to sample the measured acceleration from the accelerometer and the acceleration data of the event is obtained from the samples.

16. The method of claim 13, wherein the acceleration data comprises acceleration in each of the three mutually orthogonal directions.

17. The method of claim 13, wherein the memory device is integrally formed with the microcontroller.

18. The method of claim 13, further comprising the step of connecting to an external computing device using a connection port.

19. The method of claim 18, wherein the connection port is a wireless connection port.

20. The method of claim 18, wherein the connection port is a wired connection port.

21. The method of claim 13, wherein the microcontroller is programmed to enter a sleep mode after recording events in the memory device or activating the notification device.

22. The method of claim 13, further comprising measuring rotational acceleration using a gyroscope for measuring rotational forces applied to the helmet, and wherein the event recording further comprises readings from the gyroscope.
